(19) United States
(12) Patent Application Publication
(10) Pub. No.: US 2024/0037551 A1
(43) Pub. Date: Feb. 1, 2024

(54) Fast and Secure Distributed Ledger Network with Data Contribution Currency Acquisition System

(71) Applicant: Corey Kaizen Reaux-Savonte, London (GB)

(72) Inventor: Corey Kaizen Reaux-Savonte, London (GB)

(21) Appl. No.: 18/224,847

(22) Filed: Jul. 21, 2023

(30) Foreign Application Priority Data
Jul. 26, 2022 (GB) 2210879.9

(51) Int. Cl. G06Q 20/40

(52) U.S. Cl. CPC G06Q 20/401; G06Q 2220/00; G06Q 2230/00

(57) ABSTRACT

A distributed ledger network system designed for fast and secure transactions, energy efficient currency acquisition, fraud prevention, and resilience against network voting attacks.

### FIELD OF THE INVENTION

The disclosed embodiments relate to distributed ledger networks.

### BACKGROUND

Modern financial systems using distributed ledger technology (DLT) are rife with pitfalls—slow transaction processing, 51% attack vulnerability, fraudulent transactions, trust issues, high energy consumption, scaling issues, and currency acquisition inaccessibility to name a few. If DLT networks are to be viable for mainstream use, they need to overcome all of these obstacles.

### SUMMARY

The disclosed invention is a distributed ledger network.

In an aspect of the invention, transactions are secured using methods which significantly eliminate fraud.

In an aspect of the invention, acquisition of new currency is based on a data contribution system.

In an aspect of the invention, a voting system makes 51 percent attacks impossible at scale.

### DETAILED DESCRIPTION OF EMBODIMENTS

Reference will now be made in detail to embodiments. In the following detailed description, numerous specific details are set forth in order to provide a thorough understanding of the present invention. However, it will be apparent to one of ordinary skill in the art that the present invention may be practiced without these specific details. In other instances, well-known methods, procedures, components and networks have not been described in detail so as not to unnecessarily obscure aspects of the embodiments.

The terminology used in the description of the invention herein is for the purpose of describing particular embodiments only and is not intended to be limiting of the invention. As used in the description of the invention and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

Distributed Ledger Technology, DLT, and ledger may be used interchangeably.

The various applications and uses of the invention that may be executed may use at least one common component capable of allowing a user to perform at least one task made possible by said applications and uses. One or more functions of the component may be adjusted and/or varied from one task to the next and/or during a respective task. In this way, a common architecture may support some or all of the variety of tasks.

Unless clearly stated, the following description is not to be read as:
the assembly, position or arrangement of components;
how components are to interact; or
the order in which steps must be taken to compose the present invention.

Attention is now directed towards embodiments of the invention.

The network system requirements are:
nodes which store account balance information using a distributed ledger;
nodes responsible for verifying transactions, referred to as a witness node;
nodes which store their own account balance information without using the network's distributed ledger;
a system which assigns a witness node a reference value when the witness is connected to the network, referred to as a virtual coordination system; and, optionally
a system which stores the account balance information for the network using a private ledger, referred to as a central node;
In some embodiments, a single device may operate as multiple nodes/systems.

Prior to a transaction being possible:
A witness node must be connected to the network, and a virtual coordination system (V) needs to assign it a reference value.

An example of the operational protocol for direct transactions is as follows. An arrow (→) indicates an optional step:
A transaction is initiated between the sender (S) and the recipient (R).
   S must use at least one method of biometric authentication linked to the sender account and/or node from which the transaction is being initiated in order for it to begin.
   S sends R a payment proposal stating their current balance and the amount to be transferred.
   R then chooses whether or not to accept the proposal. If R accepts, they send an acknowledgement to S.
   R must use at least one method of biometric authentication linked to the recipient account and/or node in order to accept the transaction.
S and R contact a central node (C), each sending their current account balance. In addition, either or both parties send at least one of the following: the transaction value and/or their own account balance should the transaction be successful.
C cross-references the information sent to it with the account balance details it holds for each party. If the information matches, S and R are notified.
V is then used by a party to determine a set/range of values for S and R, and, in some embodiments, C, to choose from. The values are based upon the reference values assigned to witness nodes connected to the network, and must be able to indicate which witness node to contact when used together. These values are passed to S, R, and, if necessary, C.
At least two parties pick values from within the set/range and share their pick with the other two parties. The corresponding witness node (W) is then contacted by S, R, and C.
S and R each send W their current account balance, and either or both parties send at least one of the following: the transaction value and/or their own account balance should the transaction be successful.
C sends W one or more of the following pieces of information: information earlier received from S and R and/or information relating to the results of its cross-referencing and/or account balance information for S and R.
W independently cross checks and verifies the received information. If all information matches up, S, R, and C are notified and the account balances for S and R are changed on all nodes.
W adds the transaction to its ledger.
The ledger update then propagates throughout the witness nodes of the network.

In embodiments without a central node, W has the duty of checking and verifying data, and S and R can use V at any point after transaction initiation to determine which W to use.

The requirements for escrow transactions being possible are:
nodes that are able to complete or reverse pending transactions they have been assigned, referred to as escrow nodes; and
a system which assigns an escrow node a reference value when the escrow node is connected to the network, referred to as an escrow coordination system;

An example of the operational protocol for escrow transactions works similar to the protocol for direct transactions, with the exception of the following:
S or R selects to perform an escrow transaction at the start and one needs to input details of the condition for the release of funds, which is then sent to the other party. The party receiving the condition information then needs to accept them for the transaction to continue.
In the same way as V, the escrow coordination system (X) sends values to S, R, and, if desired, C, to select from which, when used together, indicates which escrow node (E) is assigned to the transaction.
The escrow condition details also need to be sent by S and R to W for cross-referencing.
Once W has verified the information and the other parties have been notified, funds are transferred from S to E instead of R, and a pending transaction notification containing the transaction information is listed on the accounts of S, R, and E.
The ledger is updated with transaction information.
If and when both S and R confirm that the conditions for the release of funds have been met, the funds are automatically released by E to R.
If both S and R choose to reverse the transaction, the funds are automatically sent back to S.
In the event that one party chooses to confirm and the other chooses to reverse or contend, E is responsible for either reversing or releasing the funds.

With such a simple process for verifying transactions that does not require large amounts of processing power to keep the network moving, unlike with blockchain, easier methods can be used for the acquisition of newly minted currency.

One example of such a system is a data contribution system. This requires network nodes (D) to be set up to receive specific types of data which they can process and verify. Users of the network can then contribute data to the network from their own node. The data is sent to D. If D verifies and approves the data, the user is rewarded with currency.

In some embodiments, other conditions must be met before a user is rewarded currency. Two examples of such conditions are:
1. Quantity: A user must submit a number of approved sets of data before being rewarded currency. This condition requires the network to track the number of contributions that are approved for an account.
2. Voting: A user's contributed data must be voted on by peers on the network before it can be approved. This condition requires a voting system implemented which allows users to see contributed data on the network, and a condition in relation to the number of votes in favour of the data before it is approved.

To prevent 51 percent attacks, voting system restrictions must be implemented. An example method of doing this is:
1. Limit the number of votes per contribution per account.
2. Restrict voting accounts to specific node types.
3. Limit the number of voting accounts per node.
4. Limit the number of voting nodes per device.
5. Require biometric authentication to cast a vote.

At a scale where a 51 percent attack would be worth the trouble, it would be virtually impossible for an individual or group to physically acquire enough resources to make it happen, nor could they hack devices on a large enough scale to do so due to biometric authentication.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

1. A distributed ledger network, comprising:
nodes responsible for verifying transactions using account balance information from a distributed ledger, referred to as a witness node;
nodes which store account balance information without using the network's distributed ledger;
a system which assigns a witness node a reference value when the witness node is connected to the network;
wherein:
witness nodes connect to the network and are assigned a reference value;
the sender and recipient in a transaction send information to at least one other node to be cross-referenced and verified against details held in a distributed ledger;
at least two nodes involved in a transaction select from a set or range of possible values which, when used together, reference the witness node to be used in the verification process of the transaction; and
the witness node cross-references information sent from at least one node with information it has access to regarding the sender and recipient accounts, ensuring information matches before a transaction is verified and completed.

2. The distributed ledger network of claim 1, including nodes that are able to complete or reverse pending transactions it has been assigned, referred to as escrow nodes.

3. The escrow nodes of claim 2, wherein the network includes a system which assigns an escrow node a reference value when the escrow node is connected to the network, referred to as an escrow coordination system.

4. The escrow coordination system of claim 3, wherein the system provides at least two nodes involved in a transaction a set or range of possible values, and at least two nodes involved in a transaction select from the set or range of possible values, which, when used together, reference the escrow node to be used for the storing of funds.

5. The escrow nodes of claim 2, wherein the nodes are used to store funds for pending transactions.

6. The distributed ledger network of claim 1, including nodes that are set up to receive specific types of user contributed data which are processed and verified for the purpose of issuing currency in response.

7. The distributed ledger network of claim 1, including a user voting system.

8. The voting system of claim 7, wherein restrictions are implemented which limit the number of votes a user can cast.

9. A method for currency acquisition on a distributed ledger network, the method comprising:
a user contributing specific data to the network;
a network node processing and verifying the data;
network peers casting votes on the contributed data;
a condition in relation to the number of votes cast in favour of the data being met;
contributed data being approved; and
the contributing user receiving currency as a reward for approved contributed data.
